(19) United States
(12) Patent Application Publication
(10) Pub. No.: US 2014/0023942 A1
(43) Pub. Date: Jan. 23, 2014

(54) ZINC CELLS HAVING IMPROVED ANODE COMPOSITION AND THEIR USE

(71) Applicant: VARTA Microbattery GmbH, Ellwangen (DE)

(72) Inventors: Cornelia Csrenko, Aalen (DE); Bernd Kreidler, Ellwangen (DE); Ulrich Kohls, Aalen (DE); Hermann Loffelmann, Ellwangen (DE); Andreas Rupp, Spraitbach (DE)

(21) Appl. No.: 13/943,046

(22) Filed: Jul. 16, 2013

(30) Foreign Application Priority Data
Jul. 18, 2012 (EP) 12176884.0

(51) Int. Cl. H01M 4/86; H01M 4/04

(52) U.S. Cl. CPC H01M 4/8652; H01M 4/04
USPC 429/406; 252/512

(57) ABSTRACT

An electrochemical cell in the form of a button cell includes an electrode 1) composed essentially of zinc or a zinc alloy, and 2) aluminum hydroxide and/or at least one aluminate, and a method of producing an electrochemical cell including mixing a zinc powder or a zinc-containing powder with aluminum hydroxide and/or at least one aluminate and, optionally, an electrode binder, a conductivity-improving additive and/or a corrosion inhibitor, to form an electrode.

### TECHNICAL FIELD

This disclosure relates to electrochemical cells, in particular in button cell form, comprising an electrode, which is composed essentially of zinc or of a zinc alloy. The disclosure also relates to a method of producing such a cell and to the use of such cells.

### BACKGROUND

Electrochemical cells having an electrode made of zinc or made of a zinc alloy, a so-called zinc electrode, can be used in a versatile manner. Zinc electrodes are part of zinc/air cells, which in button cell form are particularly required in the field of hearing aid devices. Further examples for cells having a zinc anode are zinc manganese oxide cells, zinc silver oxide cells and zinc mercury oxide cells. Those cells are all characterized by a high energy content and a relatively stable voltage state.

Furthermore, electrodes made of zinc are also used in gas generation cells. An example of a gas generation cell is described in DE 35 32 335 A1.

A pulsed discharge of a cell takes is of particular importance in the field of mobile communication. For example communication devices operated in GSM mode (Global System for Mobile Communications mode), in UMTS-TDD mode (Universal Mobile Telecommunications System in Frequency Division Duplex mode) mode, LTE mode (Long Term Evolution mode), WiMAX mode (Worldwide Interoperability for Microwave Access mode) or in DECT mode (Digital Enhanced Cordless Telecommunications mode) are operated in a pulse mode and, therefore, need to be supplied with electric energy in pulsed form.

There is nonetheless a need to provide electrochemical cells having a zinc electrode characterized by a particularly stable voltage profile, in particular in the case of pulsed discharge.

### SUMMARY

We provide an electrochemical cell in the form of a button cell including an electrode 1) composed essentially of zinc or a zinc alloy, and 2) aluminum hydroxide and/or at least one aluminate.

We also provide a method of producing an electrochemical cell including mixing a zinc powder or a zinc-containing powder with aluminum hydroxide and/or at least one aluminate and, optionally, an electrode binder, a conductivity-improving additive and/or a corrosion inhibitor, to form an electrode.

We further provide a method of operating an electronic device in pulse mode including supplying the device with electric energy from the electrochemical cell.

We further yet provide an electronic device operated in pulse mode including the cell.

### BRIEF DESCRIPTION OF THE DRAWINGS

FIG. 1a is a graph of voltage characteristics over time for a reference cell.

FIG. 1b is a graph of voltage characteristics over time for an example of our cells.

### DETAILED DESCRIPTION

Surprisingly, we found that adding a proportion of aluminum hydroxide to the zinc electrodes of such electrochemical cells provide a stable voltage profile, particularly in pulsed discharges. Our electrochemical cells include at least one electrode composed essentially of zinc or of a zinc alloy and which has a proportion of aluminum hydroxide and/or of at least of one aluminate.

As is well-known, aluminum hydroxide at room temperature is a solid substance usually having a white coloration, which is generally hardly soluble or insoluble in water. Aluminum hydroxide exists in several modifications. Both the known modifications of aluminum orthohydroxide Al(OH)₃ (γ aluminum, β aluminum hydroxide and triclinic aluminum hydroxide) and the known modifications of aluminum metahydroxide AlO(OH), namely orthorhombic α-aluminum oxide hydroxide and orthorhombic γ aluminum oxide hydroxide can be used.

Under the influence of bases, all of the modifications react to aluminates in which aluminum is present in the form of a complex anion [Al(OH)₄]⁻ having hydroxide ions as ligands.

Optionally, it is possible for the zinc electrodes to contain a proportion of at least one aluminate instead of the aluminum hydroxide or in addition to the latter. In particular, alkali aluminates such as sodium aluminate or potassium aluminate, alkaline earth aluminates such as calcium aluminate as well as zinc aluminate, can be considered as aluminates for that purpose. The aluminates can be present separately or in a combination thereof in the negative electrode of an electrochemical cell.

It is preferred that the electrode contains one or a plurality of other components besides the zinc or the zinc alloy as well as the aluminum hydroxide and/or the at least one aluminate.

In particular, it is preferred that the electrode comprises an electrode binder. The electrode binder can be selected from commercially available products. Those skilled in the art can readily determine which electrode binder is suitable for electrochemical cells with zinc electrodes.

In a particularly preferred configuration, a binder on the basis of carboxyl methyl cellulose and/or on the basis of a carboxyl methyl cellulose derivative is used. As an alternative, binders based on polyacrylic acid can be used as well.

As a further additional component, the electrode may contain a conductivity-improving additive. For example, that can be a carbon-based conductor, for example, carbon black, graphite or carbon nanotubes (CNTs). In addition or instead of the carbon-based conductor, also an alternative conductor, for example, particulate copper, can be used.

Where appropriate, the electrode comprises a corrosion inhibitor. A corrosion inhibitor may be understood as an additive which counteracts the self-corrosion of the zinc contained in the electrode, which in turn could result in undesirable hydrogen formation. Conventionally, metallic mercury was frequently used in zinc electrodes for that purpose. In the past years however, mercury was displaced by substitute additives, for example by indium or bismuth, for reasons of environmental protection.

Particularly preferred, the electrode comprises the following components in the following proportions:
the zinc and/or the zinc alloy in a proportion of about 90 weight percent to about 99.5 weight percent, preferably about 95 weight percent to about 99.5 weight percent, in particular about 97.5 weight percent to about 99.5 weight percent,
the aluminum hydroxide and/or the at least one aluminate in a proportion of about 0.01 weight percent to about 10 weight percent, preferably about 0.01 weight percent to about 5 weight percent, particularly preferred about 0.25 weight percent to about 5 weight percent, in particular about 0.5 weight percent to about 2 weight percent,
the electrode binder in a proportion of about 0 weight percent to about 10 weight percent, preferably about 0.1 weight percent to about 5 weight percent, in particular about 0.25 weight percent to about 2.5 weight percent,
the conductivity improving additive in a proportion of about 0 weight percent to about 10 weight percent, preferably about 0.25 weight percent to about 5 weight percent, in particular about 0.25 weight percent to about 2.5 weight percent,
the corrosion inhibitor in a proportion of about 0 weight percent to about 10 weight percent, preferably about 0.1 weight percent to about 5 weight percent, in particular about 0.25 weight percent to about 2.5 weight percent.

In this regard, the above proportions may be adapted to one another such that they add up to 100 weight percent in total. Furthermore, it is to be emphasized that all weight indications refer to the dry weight of the electrode, i.e., without consideration of an electrolyte to impregnate the electrode as the case may be.

Furthermore, the conductivity-improving additive and the corrosion inhibitor may be strictly facultative features of the cells.

Particularly preferred, the cells comprise an alkaline electrolyte. Common alkaline electrolytes are, for example, aqueous sodium hydroxide or potassium hydroxide solutions.

In view of the above explanations regarding the chemical influence of bases on aluminum hydroxide, it becomes apparent that in the presence of an alkaline electrolyte, aluminum hydroxide contained in our cells is at least partially converted into one or multiple aluminates. Thus, for example, under the influence of a caustic potash solution as a base in an electrode containing zinc and aluminum hydroxide, potassium aluminates and zinc aluminates can develop at the same time.

The electrode being essentially composed of zinc or a zinc alloy and comprising a proportion of aluminum hydroxide and/or a proportion of at least one aluminate generally is the negative electrode of the cells.

Particularly preferably, the cells comprise an air cathode, a silver oxide cathode, a mercury oxide cathode or a manganese oxide cathode. Correspondingly, the cells are preferably zinc/air cells, zinc silver oxide cells, mercury oxide zinc cells or zinc manganese oxide cells. The structure of all of the cell types is known and thus does not require a further detailed explanation.

The cells may also comprise a hydrogen cathode as described in DE 35 32 335 C2, for example. Thus, the cells may also be gas generation cells, in particular hydrogen evolution cells.

Particularly preferred, but not mandatorily, the cells are button cells.

To produce the described electrode, zinc powder or a zinc-containing powder (from a zinc alloy) are mixed with aluminum hydroxide (alternatively: in addition to or instead of the aluminum hydroxide with an aluminate). Where appropriate, the aforesaid electrode binder and/or the conductivity-improving additive and/or the corrosion inhibitor may be added.

The obtained mixture can subsequently be pressed to form a molded body and be placed in a housing as an electrode. As an alternative, it is also possible to introduce (trickle) the mixture into the housing in the form of powder. The variant is particularly preferred in the production of zinc/air cells.

Generally, an alkaline electrolyte may be added to the negative electrode upon insertion of the electrode in the aforementioned housing. Subsequently, the housing may be sealed in a liquid-tight manner.

However, it is also possible to add the electrolyte to the mixture external of the housing and introduce it into the housing in the form of a paste.

Our cells have been found to be in particular suitable to supply electronic devices operated in pulse mode with electric energy. In particular in the case of pulsed discharge they show a very stable voltage profile. Thus, a method of operating an electronic device in pulse mode, wherein the devices are supplied with electric energy from an electrochemical cell as described above, and electronic device which are operated in pulse mode and comprising such an electrochemical cell are a part of this disclosure.

Preferably the electronic device is a communication device operated in GSM mode (Global System for Mobile Communications mode), in UMTS-TDD mode (Universal Mobile Telecommunications System in Frequency Division Duplex mode) mode, LTE mode (Long Term Evolution mode), WiMAX mode (Worldwide Interoperability for Microwave Access mode) or in DECT mode (Digital Enhanced Cordless Telecommunications mode), in particular a cordless or cellular mobile telephone device.

Further features and advantages arise from the following description of an example. Individual features described above or in the appended claims can in each case be realized on their own or in combinations thereof in the example. The examples merely serve for explanation and a better understanding and are not to be understood as limiting in any manner.

### EXAMPLE

Electrodes for zinc/air cells, zinc silver oxide cells and hydrogen evolution cells were produced from zinc powder, aluminum hydroxide and carboxymethylcellulose as electrode binder(s). For that purpose, the aforementioned electrode components were mixed in the following proportions:

| | Zinc/Air | Zinc/Ag₂O | Zinc-H2 |
|---|---|---|---|
| Electrode Binder | 0.3 weight % | 1.0 weight % | 1.5 weight % |
| Al(OH)₃ | 0.5 weight % | 1.0 weight % | 0.5 weight % |
| Zinc Powder | 99.2 weight % | 98.0 weight % | 98.0 weight % |

The mixture for the zinc silver oxide cell was pressed into a tabloid electrode and mounted as a negative electrode in a customary button cell housing.

The mixtures for the zinc/air cells and the hydrogen evolution cells were trickled in dry form into a button cell lid. The lid was subsequently combined with a cup which comprised inlet and outlet openings, respectively, for atmospheric oxygen and hydrogen.

Prior to sealing the housing, the electrodes produced were impregnated with a 30% potassium hydroxide solution.

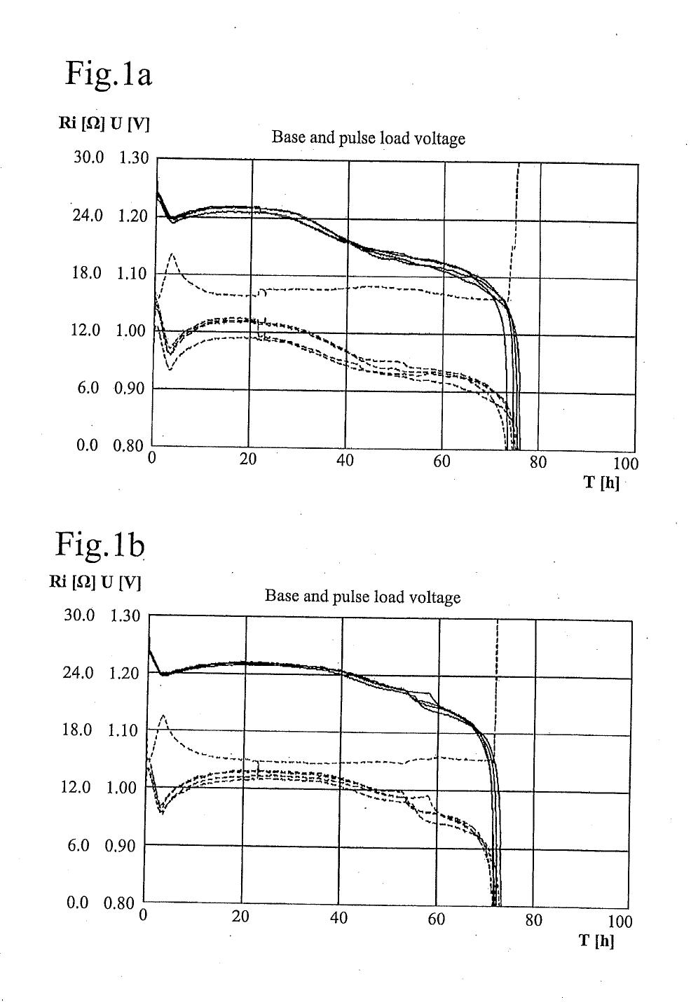

Tests with zinc/air cells revealed that in the case of a pulsed resistance discharge, significantly improved voltage state values were obtained compared to reference cells. The voltage profiles of an example of our zinc/air cells as well as of a reference cell in the case of a pulsed resistance discharge are illustrated in FIGS. 1a and 1b, FIG. 1a showing the voltage characteristic of the reference cell and FIG. 1b that of our cells.

Furthermore, our cells exhibited a significantly improved storage life: After one month of stocking, the capacities of our cells were measured:

| | | 1.10 V | | | 1.05 V | | |
|---|---|---|---|---|---|---|---|
| | Ch. | t[h] | Q[mAh] | A[mWh] | t[h] | Q[mAh] | A[mWh] |
| | 21 | 178.0 | 282.0 | 349.4 | 179.6 | 286.9 | 354.8 |
| | 22 | 192.8 | 290.5 | 359.0 | 193.9 | 293.6 | 362.5 |
| | 23 | 192.8 | 290.3 | 359.0 | 194.0 | 294.0 | 362.9 |
| | 30 | 179.7 | 287.1 | 355.2 | 193.4 | 292.3 | 360.9 |
| | 67 | 192.9 | 290.8 | 360.0 | 194.0 | 294.0 | 363.4 |
| Mean | | 187.2 | 288.1 | 356.5 | 191.0 | 292.2 | 360.9 |
| Std. | | 6.9 | 3.4 | 3.9 | 5.7 | 2.7 | 3.2 |
| dev. | | | | | | | |

For the reference cells, the following reference values were determined:

| | | 1.10 V | | | 1.05 V | | |
|---|---|---|---|---|---|---|---|
| | Ch. | t[h] | Q[mAh] | A[mWh] | t[h] | Q[mAh] | A[mWh] |
| | 73 | 170.0 | 258.0 | 319.5 | 172.0 | 264.0 | 326.2 |
| | 74 | 176.0 | 276.0 | 343.4 | 178.0 | 282.0 | 350.0 |
| | 75 | 172.0 | 264.0 | 328.6 | 174.0 | 270.0 | 335.3 |
| | 76 | 174.0 | 270.0 | 335.4 | 176.0 | 276.0 | 342.0 |
| | 77 | 172.0 | 264.0 | 327.7 | 174.0 | 270.0 | 334.4 |
| Mean | | 172.8 | 266.4 | 330.9 | 174.8 | 272.4 | 337.6 |
| Std. | | 2.0 | 6.1 | 8.0 | 2.0 | 6.1 | 8.0 |
| dev. | | | | | | | |

1. An electrochemical cell in the form of a button cell comprising an electrode 1) composed essentially of zinc or a zinc alloy, and 2) aluminum hydroxide and/or at least one aluminate.

2. The cell according to claim 1, wherein the at least one aluminate comprises at least one member selected from the group consisting of sodium aluminate, potassium aluminate, calcium aluminate and zinc aluminate.

3. The cell according to claim 1, wherein a negative electrode comprises the zinc or the zinc alloy, the aluminum hydroxide and/or the at least one aluminate, and at least one of:
an electrode binder,
a conductivity-improving additive, and
a corrosion inhibitor.

4. The cell according to claim 1, wherein a negative electrode comprises components in proportions below, wherein the proportions are adapted to one another such that they add up to 100 weight percent in total:
the zinc and/or the zinc alloy in a proportion of about 90 weight percent to about 99.5 weight percent,
the aluminum hydroxide and/or the at least one aluminate in a proportion of about 0.1 weight percent to about 10 weight percent,
the electrode binder in a proportion of about 0 weight percent to about 10 weight percent
the conductivity-improving additive in a proportion of about 0 weight percent to about 10 weight percent,
the corrosion inhibitor in a proportion of about 0 weight percent to about 10 weight percent.

5. The cell according to claim 1, further comprising an alkaline electrolyte.

6. The cell according to claim 1, further comprising an air cathode, a silver oxide cathode, a mercury oxide cathode or a hydrogen cathode.

7. A method of producing an electrochemical cell comprising: mixing a zinc powder or a zinc-containing powder with aluminum hydroxide and/or at least one aluminate and, optionally, an electrode binder, a conductivity-improving additive and/or a corrosion inhibitor, to form an electrode.

8. A method of operating an electronic device in pulse mode comprising supplying the device with electric energy from the electrochemical cell according to claim 1.

9. The method according to claim 8, wherein the electronic device is a communication device operated in GSM mode (Global System for Mobile Communications mode), in UMTS-TDD mode (Universal Mobile Telecommunications System in Frequency Division Duplex mode) mode, LTE mode (Long Term Evolution mode), WiMAX mode (Worldwide Interoperability for Microwave Access mode) or in DECT mode (Digital Enhanced Cordless Telecommunications mode).

10. An electronic device that operates in pulse mode comprising the cell according to claim 1.

11. The device according to claim 10, wherein the electronic device is a communication device operated in GSM mode (Global System for Mobile Communications mode), in UMTS-TDD mode (Universal Mobile Telecommunications System in Frequency Division Duplex mode) mode, LTE mode (Long Term Evolution mode), WiMAX mode (Worldwide Interoperability for Microwave Access mode) or in DECT mode (Digital Enhanced Cordless Telecommunications mode).
